(19) United States
(12) Patent Application Publication
(10) Pub. No.: US 2019/0048252 A1
(43) Pub. Date: Feb. 14, 2019

(54) Borate Crosslinked Fracturing Fluids

(71) Applicant: BJ Services, LLC, Tomball, TX (US)

(72) Inventors: Diankui Fu, Houston, TX (US); Angel Gonzalez, Katy, TX (US); Warren Zemlak, The Woodlands, TX (US)

(73) Assignee: BJ Services, LLC, Tomball, TX (US)

(21) Appl. No.: 15/480,311

(22) Filed: Apr. 5, 2017

(51) Int. Cl. C09K 8/68; C09K 8/90; E21B 43/26

(52) U.S. Cl. CPC C09K 8/685; C09K 8/90; E21B 43/267; C09K 2208/24; C09K 2208/26; E21B 43/26

(57) ABSTRACT

Borate crosslinked fluids are provided for use in oil and gas well fracturing operations. The fluids have relatively low loadings of galactomannan gums such as guar. The guar is present in an amount from about 10 to about 15 ppt. A borate crosslinking agent comprising ulexite is used to crosslink the guar and control the viscosity of the fluid.

### FIELD OF THE INVENTION

The present invention relates to fluids used in oil and gas well fracturing operations and, and more particularly, to borate crosslinked fracturing fluids with relatively low loadings of galactomannan gums such as guar.

### BACKGROUND OF THE INVENTION

Hydrocarbons, such as oil and gas, may be recovered from various types of subsurface geological formations. The formations typically consist of a porous layer, such as limestone and sands, overlaid by a nonporous layer. Hydrocarbons cannot rise through the nonporous layer, and thus, the porous layer forms an area or reservoir in which hydrocarbons will collect. A well is drilled through the earth until the hydrocarbon bearing formation is reached. Hydrocarbons then can flow from the porous formation into the well.

A modern oil well typically includes a number of tubes telescoped wholly or partially within other tubes. That is, a well is first drilled to a certain depth. Larger diameter pipes, or casings, are placed in the well and cemented in place to prevent the sides of the borehole from caving in. After the initial section has been drilled, cased, and cemented, drilling will proceed with a somewhat smaller well bore. The smaller bore is lined with somewhat smaller pipes or “liners.” The liner is suspended from the original or “host” casing by an anchor or “hanger.” A well may include a series of smaller liners, and may extend for many thousands of feet, commonly up to and over 25,000 feet.

Many oil and gas bearing geological formations, such as sandstone, are very porous. Hydrocarbons are able to flow easily from the formation into a well. Other formations, however, such as shale, limestone, and coal beds, are only minimally porous. The formation may contain large quantities of hydrocarbons, but production through a conventional well may not be commercially practical because hydrocarbons flow though the formation and collect in the well at very low rates. The industry, therefore, relies on various techniques for improving the well and stimulating production from formations.

In general, such techniques share the dual goals of (a) increasing the surface area of the formation exposed to the well, and (b) increasing the conductivity of fluids through the formation. That is, they increase the number and size of hydrocarbon flow paths through the formation and enhance the ability of fluid to flow easily through the flow paths. They may be applied to relatively porous formations, but are critical for economic recovery of hydrocarbons from minimally porous formations such as shale and other so-called “unconventional” formations.

Perhaps the most important stimulation technique is the combination of horizontal well bores and hydraulic fracturing. A well will be drilled vertically until it approaches a formation. It then will be diverted, and drilled in a more or less horizontal direction, so that the borehole extends along the formation instead of passing through it. More of the formation is exposed to the borehole, and the average distance hydrocarbons must flow to reach the well is decreased. Fractures then are created in the formation which will allow hydrocarbons to flow more easily from the formation.

Fracturing a formation is accomplished by pumping fluid into the well at high pressure and flow rates. Fluid is forced into the formation at rates faster than can be accepted by the existing pores, fractures, faults, vugs, caverns, or other spaces within the is formation. Pressure builds rapidly to the point where the formation fails and begins to fracture. Continued pumping of fluid into the formation will tend to cause the initial fractures to widen and extend further away from the well bore.

At a certain point, the initial “pad” of fluid will create and enlarge fractures to the point where proppants are added to the fluid. Proppants are solid particulates, such as grains of sand, which are carried into the fractures by the fluid. They serve to prevent the fractures from closing after pumping is stopped. The proppant typically will be added in increasing concentration as the formation continues to accept fluid and fracturing continues. In shale formations, for example, fractures may extend 150 to 300 feet away from the well bore.

In any event, when the desired degree of fracturing has been achieved, pumping is stopped and the well is “shut in.” That is, valves at the surface are closed, and fluid is held in the well. As the well is shut in, the formation begins to relax and fractures tend to close on the entrained proppant. Depending on the formation and the operation, the well may be shut in for a few minutes or hours. Eventually the surface valves will be opened to allow the fluid to “clean out” of the fractures. That is, fluid will flow out of the formation, leaving proppant packed fractures that will provide additional flow paths for produced hydrocarbons.

Fracturing operations typically require large amounts of fluid. Fracturing a horizontal well through shale, for example, usually requires from about 50 to about 100 thousand barrels (US oil barrels). Given such quantities, even relatively inexpensive components can add up to significant costs. Conversely, a small reduction in the relative amounts components can provide significant cost savings.

The systems required for fracturing a well also are extensive and complex. They include fluid tanks, mixing and blending units, and pumping equipment. Moreover, a single pump is rarely, if ever, able to provide flow rates and pressures sufficient for modern fracturing operations. The output from an array of pumps must be manifolded to provide the required flow rates and pressures. Frac jobs also have become more extensive, both in terms of the pressures required to fracture a formation and the time required to complete all stages of an operation. Given the expense of acquiring and is operating such systems, it is important that a fracturing fluid efficiently fracture and deliver proppant into a formation.

For example, the pumping pressure required to fracture a formation depends not only on the physical properties of the formation of the formation and the depth at which it is located, but also on the pressure loss experienced as a fracturing fluid travels through the casing and liners on its way to the formation. The liners, as noted, may extend for many thousands of feet. Friction between the fluid and liner is inevitable and over such distances can be significant. As friction between the fluid and liner is reduced, however, pressure losses will be reduced and the same formation may be fractured with less pumping pressure. Lower pumping pressure often translates into lower cost.

The efficiency at which a fluid delivers proppant into a formation also is important, not only in terms of improving production from the well, but also in terms of the cost of the fracturing operation. If a fluid cannot efficiently transport proppant, more fluid must be pumped in order to adequately fill the fractures with proppant. More efficient fluids usually mean less total fluid pumped, i.e., less fluid costs, less time spent pumping, i.e., less operational costs, and less fluid that must be recovered and treated, i.e., less disposal costs. Thus, the choice of fracturing fluid will not only impact the cost of the fluid itself, but also can significantly impact the operational costs of a fracturing operation.

Early fracturing fluids were oil-based fluids consisting of gelled hydrocarbons, such a napalm. Given the safety and environmental concerns with such fluids, however, the industry relatively quickly moved to water based fluids. Hydrocarbon-based fluids using liquefied natural gas (LNG) and liquefied petroleum gas (LPG) still may be useful for water-sensitive formations, such as those with high clay content. Energized fluids, which contain relatively small amounts of water and large fractions of gas, also are used in water-sensitive formations. Less commonly, water-based systems incorporating a viscoelastic surfactant (VES) are used.

The most common frac fluids, however, are one of three types of water-based fluids: “slickwater,” linear or uncrosslinked fluids, and crosslinked fluids. Water may comprise up to 99% by weight (wt %) of the liquid phase. They may include various additives, such as buffers, clay inhibitors, corrosion inhibitors, surfactants, and biocides, to address issues specific to particular formations. There are no hard and fast definitions, but in general the three most common water-based fluids are distinguished by their primary components and the manner in which they are designed to facilitate the fracturing process.

Slickwater fluids are composed primarily of water and low concentrations of a friction reducer. Typically, the friction reducers are long chain, high molecular weight polyacrylamide derivatives and copolymers. They tend to reduce friction pressure loss as fluid is pumped into the formation by decreasing turbulent flow through the liner and making it more laminar. They can be quite effective—yielding up to 70% reduction in friction pressure and a corresponding reduction in the required pumping pressure.

Slickwater fluids have certain advantages, especially in the context of minimally permeable or “tight” formations like shale. They tend to produce relatively small, but widely distributed fracture patterns. Slickwater fluids, however, are not very efficient in delivering proppant into fractures. The fluid is lighter and less viscous. More fluid is needed to carry the same amount of proppant. It also must be pumped into the formation at higher rates to minimize the tendency of the proppant to settle. Pumping rates of 100 barrels per minute (bbl/min) are common, and higher pumping rates generally means more pumps and more expense.

Linear or uncrosslinked fluids are composed primarily of water and a gelling agent. Guar is the most common gelling agent. Other galactomannan gums and their derivatives, however, are used as well, such as hydroxypropyl guar (HPG), carboxymethyl guar (CMG), and carboxymethyl hydroxypropyl guar (CMHPG). Cellulosic gelling agents, such as hydroxyethyl cellulose (BEC) and carboxymethyl hydroxyethyl cellulose (CMHEC), also have also been used as gelling agents.

As compared to slickwater fluids, linear fluids are able to deliver proppant into fractures more efficiently. They are much more viscous, more gel-like. Proppant tends to be suspended in the fluid instead of dropping out. A viscosity of at least about 25 centipoise (cP) generally is viewed as sufficient to provide adequate suspension, and thus, linear fluids typically will be loaded to provide at least 25 cP. Guar, for example, typically is loaded into linear fluids in amounts ranging from about 20 to about 60 pounds per 1,000 gallons of fluid (ppt).

Crosslinked fluids are composed primarily of water, a gelling agent, and a crosslinking agent. As with linear fluids, the most common gelling agent is guar. HPG also is commonly used in crosslinked fluids. As their name implies, crosslinkers create links between the polymers of the gelling agent, increasing their effective molecular weight and increasing the viscosity imparted to the fluid. Crosslinked fluids, therefore, generally can provide viscosities equivalent to linear fluids with lower amounts of gelling agent. Alternately, crosslinkers can provide higher viscosities at equivalent loadings when, for example, it may be necessary to suspend larger, heavier proppants. Guar, for example, typically is loaded at rates from 20 to 35 ppt in crosslinked fluids.

For higher temperature applications, above about 300° F., zirconate and titanate crosslinkers generally are preferred. At lower temperatures, the most common 3.7 crosslinker is a boron compound. Boric acids and more soluble sodium borates such as borax are the most common crosslinker. Less soluble borates, such as calcium and magnesium borates also have been used. Such borates have included polyborates, such as ulexite and colemanite. Given that they are less soluble, they have generally been used to delay crosslinking of guar. By delaying crosslinking, viscosity will remain lower, and friction losses will be reduced as fluid is pumped through the liner.

Borate generally will be added in amounts sufficient to provide a degree or density of crosslinks between polymer units in the gelling agent which is required to achieve a desired viscosity. Most commonly, that will mean a degree of crosslinking of from about 0.1 to about 1 percent by mole (mole %), i.e., about 0.1 to 1% of polymer units will be crosslinked by a borate ion. In absolute terms, the amount of borate required to achieve a particular crosslink density may vary significantly. Polyborates, for example, can provide multiple borate ions for each mole of compound, and in general smaller amounts may be required. The degree of crosslinking also varies depending on the pH and temperature of the gelled fluid. Crosslinks are preferentially formed at a pH between 10-12. As pH increases, more borate ions typically are released, which may lead to more crosslinking. On the other hand, crosslinking generally will be diminished as temperature increases. Thus, for example, increasing the pH for higher temperature applications may help to maintain an desired degree of crosslinking.

Given their higher viscosities, gelled fluids, whether linear or crosslinked, are generally regarded as being more efficient than slickwater fluids in delivering proppant uniformly through fractures. Less fluid typically is required. They also are pumped at much lower flow rates than slickwater fluids. Flow rates usually are below 60 bbl/min.

It is important, however, that a fracturing fluid not transport proppant out of the fractures once the well is opened for production and fluid begins to clean out of the formation. Gelling agents and other polymers in linear and crosslinked fluids have a greater tendency to carry proppant out of fractures. They also can diminish the ability of fluids to flow through the fracture, that is, the conductivity of the fracture. They may become entrained in the formation or proppant pack, and their lingering presence can impede the flow of hydrocarbons during production. Ideally, all polymer will flow out of the fractures during clean out without transporting proppant along with it. Generally speaking, both goals are accomplished by adding a “breaker” to lower the fluid's viscosity—ideally to a viscosity approximating that of water—prior to clean out.

Crosslinks formed with borate crosslinks, for example, may be reversed by lowering the pH of the fluid. Elimination of crosslinks will reduce the fluid's viscosity and can improve the clean out of the gelling polymers. Breakers also can lower the viscosity by breaking the polymer chains. Shorter chain polymers generally will impart less viscosity to a fluid and will clean out faster and better than longer chain polymers. Common breakers include enzymes, oxidizers, polyols, and aminocarboxylic acids.

It will be appreciated that the economics and characteristics of a particular well may render it more suitable to a particular fracturing operation and fluid over another. A particular fluid may provide extraordinary results in one well and be completely unsuitable for use in another. Thus, general statements should be taken as such, and not as definitive, immutable principles. Nevertheless, borate crosslinked fluids have been used widely and are viewed by many as superior fluids for fracturing many formations.

At the same time, borate crosslinked fluids continue to suffer from many of the deficiencies mentioned above. Less viscous fluids reduce pumping costs. Heavier, more viscous fluids can suffer greater pressure losses as they are pumped into a formation, and therefore, may unnecessarily increase the pumping capacity required to fracture a particular well. Crosslinked fluids are more efficient in delivering proppant. At the same time, they still require relatively high levels of polymer gelling agents. Higher levels of gelling agent not only increase the cost of the fluid, but also necessarily introduce more polymer into a formation, not all of which may be efficiently cleaned out of the formation prior to production. It is difficult to provide fluids which may be prepared and pumped economically, transport proppant efficiently, and clean out efficiently all at the same time.

The statements in this section are intended to provide background information related to the invention disclosed and claimed herein. Such information may or may not constitute prior art. It will be appreciated from the foregoing, however, that there remains a need for new and improved fluids for well fracturing operations and, and more particularly, to borate crosslinked fracturing fluids. Such disadvantages and others inherent in the prior art are addressed by various aspects and embodiments of the subject invention.

### SUMMARY OF THE INVENTION

The subject invention, in its various aspects and embodiments, relates generally to fluids used in oil and gas well fracturing operations, and especially to borate crosslinked fracturing fluids with relatively low loadings of galactomannan gums such as guar. The invention encompasses various embodiments and aspects, some of which are specifically described and illustrated herein. One aspect of the invention provides for aqueous well treatment fluids comprising a gelling agent and a borate crosslinking agent. The gelling agent is selected from the group consisting of galactomannan gum and derivatives thereof and is present in an amount from about 10 to about 15 ppt. The borate crosslinking agent comprises ulexite.

Other embodiments provide aqueous well treatment fluids comprising viscosity enhancing additives. The viscosity enhancing additives consist essentially of a gelling agent and a borate crosslinking agent. The gelling agent is selected from the group consisting of galactomannan gum and derivatives thereof and is present in an amount from about 10 to about 15 ppt. The borate crosslinking agent comprises ulexite.

In other aspects the invention provides for such fluids where the gelling agent is present in amounts from about 10 to about 12 ppt. Additional embodiments provide fluids where the gelling agent is guar gum.

Other embodiments and aspects of the invention provide such fluids where the crosslinking agent is present in an amount effective to provide the fluid with a viscosity of less than about 20 cP, or less than about 15 cP at high shear rates, but with a viscosity of at least about 25 cP, or at least about 50 cP at low shear rates.

Further embodiments provide such fluids where the crosslinking agent consists essentially of ulexite. Still other embodiments of such fluids where ulexite is present in amounts sufficient to provide from about 0.1 to about 1 mole % crosslinking, amounts from about 0.1 to about 0.25 g/ml, or amounts from about 0.1 to 0.2 g/ml.

The invention also includes embodiments where such fluids rapidly recover viscosity upon transitioning from high shear conditions to low shear conditions. For example, some embodiments recover from high shear rate viscosities of less than about 20 cP, or less than about 15 cP, to low shear rate viscosities of at least about 25 cP in less than about 10 seconds. Other embodiments may recover to low shear rate viscosities of at least about 50 cP in less than about 3 minutes.

Yet other embodiments provide fluids which may recover from high shear viscosities of less than about 20 cP, or less than about 15 cP, to low shear viscosities of at least about 100% greater than the high shear viscosity in less than about 10 seconds. Other embodiments may recover from high shear viscosities of less than about 15 cP to low shear viscosities of at least about 150% greater than the high shear rate viscosity in less than about 90 seconds, or at least about 200% greater than the high shear rate viscosity in less than about 2 minutes, or at least about 300% greater than the high shear rate viscosity in less than about 3 minutes.

Additional aspects and embodiments provide such fluids where the fluid does not comprise additional friction reducers or where it does not comprise additional buffers. Still other embodiment comprise such fluids which include a breaker, a proppant, or both.

The subject invention also provide novel methods of reducing the pumping pressure and enhancing the transport capability of a proppant in a hydraulic fracturing operation. Such methods comprise pumping the novel fluids, including a proppant, into a well penetrating a subterranean formation.

Other embodiments provide methods of fracturing a formation extending around a well. Such methods comprise pumping the novel fluids into the formation at a rate and pressure sufficient to form fractures in the formation.

Additional embodiments provide methods for recovering hydrocarbons from a formation extending around a well. The method comprises pumping the novel fluids into the formation. The novel fluids will comprise a proppant. The pumping will be conducted at a rate and pressure sufficient to form fractures in the formation and deposit the proppant in the fractures. The fluid injected into the formation then is allowed to flow out of the fractures along with hydrocarbons in the formation. The hydrocarbons then are recovered from the well.

Still other embodiments provide methods of controlling the viscosity of an aqueous fluid injected into a well to induce fracturing of adjacent formations. The method includes or consists essentially of adding a gelling agent selected from the group consisting of galactomannan gum and derivatives thereof in an amount from about 1.0 to about 15 ppt and a borate crosslinking agent comprising ulexite to increase the viscosity of the aqueous fluid. A breaker then is added to decrease the viscosity of the aqueous fluid.

Finally, still other aspect and embodiments of the invention will have various combinations of such features as will be apparent to workers in the art.

Thus, the present invention in its various aspects and embodiments comprises a combination of features and characteristics that are directed to overcoming various shortcomings of the prior art. The various features and characteristics described above, as well as other features and characteristics, will be readily apparent to those skilled in the art upon reading the following detailed description of the preferred embodiments and by reference to the appended drawings.

Since the description and drawings that follow are directed to particular to embodiments, however, they shall not be understood as limiting the scope of the invention. They are included to provide a better understanding of the invention and the manner in which it may be practiced. The subject invention encompasses other embodiments consistent with the claims set forth herein.

### BRIEF DESCRIPTION OF THE DRAWINGS

FIG. 1A (prior art) is a schematic illustration of an early stage of a “plug and perf” fracturing operation showing a tool string 20 deployed into a liner assembly 6, where tool string 20 includes a perf gun 22, a setting tool 23, and a frac plug 24.

FIG. 1B (prior art) is a schematic illustration of line assembly 6 after completion of the plug and perf fracturing operation, but before removal of plugs 24 from liner 6.

FIGS. 2-11 are graphical presentations of the data collected, respectively, in Examples 1 to 10 showing in particular the viscosity of Test Fluids 1 to 10 under high and low shear conditions.

In the drawings and description that follows, like parts are identified by the same reference numerals. The drawing figures are not necessarily to scale. Certain features of the embodiments may be shown exaggerated in scale or in somewhat schematic form and some details of conventional design and construction may not be shown in the interest of clarity and conciseness.

### DESCRIPTION OF ILLUSTRATIVE EMBODIMENTS

The invention, in various aspects and embodiments, is directed generally to fluids used to fracture oil and gas wells, and especially to borate crosslinked fracturing fluids with relatively low loadings of gelling agents, such as galactomannan gums such as guar.

Various specific embodiments will be described below. For the sake of conciseness, all features of an actual implementation may not be described or illustrated. In developing any actual implementation, as in any engineering or design project, numerous implementation-specific decisions must be made to achieve a developers' specific goals. Decisions usually will be made consistent within system-related and business-related constraints, and specific goals may vary from one implementation to another. Development efforts might be complex and time consuming and may involve many aspects of design, fabrication, and manufacture. Nevertheless, it should be appreciated that such development projects would be a routine effort for those of ordinary skill having the benefit of this disclosure.

The novel fracturing fluids may be used in a wide variety of formations, but are particularly useful for shale formations. Even for a particular type of formation, however, there are many approaches to fracturing wells. Typically, however, a well will be fractured in many different locations along the well bore during multiple fracturing stages. Different systems also will be used to deliver fluids into a formation. The novel fluids in general may be used in any such conventional methods and systems.

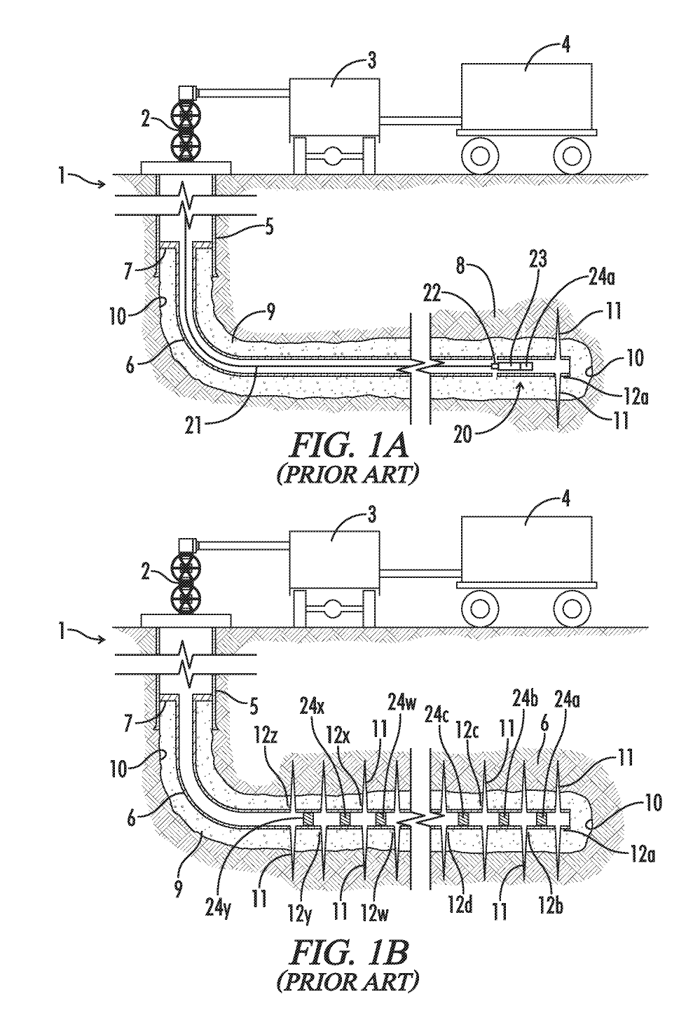

For example, “plug and perf” is a very common method of fracturing a well. An overview of a plug and perf operation is illustrated schematically in FIG. 1. As shown therein, well 1 is serviced by a well head 2, pumps 3, mixing/blending units 4, and various surface equipment (not shown). As described further below, mixing/blending units 4 will be used to prepare the novel fracturing fluids. Pumps 3 will be used to introduce the fracturing fluids into the well at high pressures and flow rates. Other surface equipment will be used to introduce tools into the well and to facilitate other completion and production operations.

The upper portion of well 1 is provided with a casing 5 which extends to the surface. A production liner 6 has been installed in the lower portion of casing 5 via a liner hanger 7. It will be noted that the lower part of well 1 extends generally horizontally through a hydrocarbon bearing formation 8 and that liner 6, as installed in well 1, is not provided with valves or any openings in the walls thereof. Liner 6 also has been cemented in place. That is, cement 9 has been introduced into the annular space between liner 6 and the well bore 10.

FIG. 1A shows well 1 after the initial stage of a frac job has been completed. A typical frac job will proceed from the lowermost zone in a well, to the uppermost zone. FIG. 1A, therefore, shows that the bottom portion of liner 6 has been perforated and that fractures 11 extending from perforations 12a have been created in a first zone near the bottom of well 1. Tool string 20 has been run into liner 6 on a wireline 21.

Tool string 20 comprises a perf gun 22, a setting tool 23, and a frac plug 24a. Tool string 20 is positioned in liner 6 such that frac plug 24a is uphole from perforations 12a. Frac plug 24a is coupled to setting tool 23 and will be installed in liner 6 by actuating setting tool 23. Once plug 24a has been installed, setting tool 23 will be to released from plug 24a. Perf gun 22 then will be fired to create perforations 12b in liner 6 uphole from plug 24a. Perf gun 22 and setting tool 23 then will be pulled out of well 1 by wireline 21.

A frac ball (not shown) then will be deployed onto plug 24a to restrict the downward flow of fluids through plug 24a. Plug 24a, therefore, will substantially isolate the lower portion of well 1 and the first fractures 11 extending from perforations 12a. Fluid then can be pumped into liner 6 and forced out through perforations 12b to create fractures 11 in a second zone. After fractures 11 have been sufficiently developed, pumping is stopped and valves in well head 2 will be closed to shut in the well. After a period of time, fluid will be allowed to flow out of fractures 11, though liner 6 and casing 5, to the surface.

Additional plugs 24b to 24y then will be run into well 1 and set, liner 6 will be perforated at perforations 12c to 12z, and well 1 will be fractured in succession as described above until, as shown in FIG. 1B, all stages of the frac job have been completed and fractures 11 have been established in all zones. Once the fracturing operation has been completed, plugs 24 typically will be drilled out and removed from liner 6. Production equipment then will be installed in the well and at the surface to control production from well 1.

It will be noted that the methods and systems for fracturing operations, and for the production of hydrocarbons, are complex and varied. Moreover, FIG. 1 are greatly simplified schematic representations of a plug and perf fracturing operation. The fluid delivery system has been greatly simplified. For example, a single pump 3 is depicted whereas in practice many pumps, perhaps 20 or more, may be used. Many different blenders, mixers, manifolding units, and the like may be used but are not illustrated. Production liner 6 also is shown only in part as such liners may extend for a substantial distance. The portion of liner 6 not shown also will be provided with perforations 12 and plugs 24, and fractures 11 will be established therein. In addition, FIG. 1 depict only a few perforations 12 in each zone, whereas typically a zone will be provided with many perforations. Likewise, a well may be fractured in any number of zones, thus liner 6 may be provided with more or fewer plugs 24 than depicted. It is believed the novel fluids may be used in the context of many known systems and methods for stimulating and producing hydrocarbons from a well. An appropriate system and method may be selected with routine effort by workers in the art. Nevertheless, it is believed the methods and systems described herein will provide an understanding of the broader context in which the novel fluids may be used.

Broader embodiments of the novel fluids are aqueous fluids having viscosity control additives which including a gelling agent, such as guar, and a borate crosslinking agent, such as ulexite. In other embodiments, the fluids may include other components. As discussed further below, it is believed that the novel fluids will have lower viscosities as they are pumped, for example, through casing 5 and liner 6 of well 1. Lower viscosities will provide lower pressure loss and more efficient pumping. Upon exiting perforations 12 and entering perforations 11, however, it is believed the novel fluids will rapidly increase in viscosity, thus allowing the fluid to more efficiently transport proppant into fractures.

### Base Fluid

The base fluid of the novel fracturing fluids primarily serves to fracture the formation and to transport proppant into the fractures. The base fluid is water, and it will be understood that water will include fresh water and salt water. “Salt water” as used herein may include unsaturated salt water or saturated salt water “brine systems”, such as a NaCl, or KCl brine, as well as heavy brines including CaCl₂, CaBr₂, and KCO₂H.

The base fluid will constitute the vast majority of the treatment fluid, generally up to in excess of 95 to 99 wt %. Depending upon the desired viscosity of the treatment fluid, more or less of the base fluid may be included, as appropriate. One of ordinary skill in the art, with the benefit of this disclosure, will recognize the appropriate amount to use for a chosen application.

### Gelling Agent

The gelling agent component of the novel fracturing fluids, together with the crosslinkers, primarily serves to enhance the viscosity of the fracturing fluid such that it is capable of suspending proppant and delivering it into fractures. They do so by hydrolysis of the polymer in the aqueous base fluid.

In various embodiments, the gelling agents are selected from the group consisting of galactomannan gums and derivatives thereof, and mixtures thereof. Galactomannans are neutral, water-soluble polysaccharides consisting of a mannose backbone with galactose side groups. More specifically, they typically consist of a β-(1→4) linked D-mannopyranose backbone with α-(1→6) linked galactopyranose side chains. They may be characterized by their mannose-to-galactose ratio, and include, in order of increasing ratio, fenugreek gum (˜1:1), guar gum (˜2:1), tara gum (˜3:1), locust bean gum or carob gum (˜4:1).

Derivatives of galactomannan gum include various copolymers thereof, such as such as hydroxypropyl guar (HPG) and carboxymethyl hydroxypropyl guar (CMHPG). In accordance with this aspect of the disclosure, the term “copolymer,” as used herein, is not limited to polymers comprising two types of monomeric units, but is meant to include any combination of monomeric units, e.g., terpolymers, tetrapolymers, and the like.

Thus, preferred gelling agents may be selected from the group consisting of guar, hydroxypropyl guar, and carboxymethyl hydroxypropyl guar, and mixtures thereof. Guar is an especially preferred gelling agent. Guar has been reported to have a weight-average molecular weight (M_{w}) of 2.13·10⁸ daltons (Da), a number-average molecular weight (Mₙ) of 1.25·10⁷, and a polydispersity index D (M_{w}(Mₙ) of 17.0. Y. Liu et al., Physicochemical Characteristics of Gradual Fractionation Ingredients of Industrial Galactomannan Gums from Gleditsia microphylla and Cyamopsis tetragonoloba, BioResources 11(3), 7046-7060 (2016).

The gelling agents may be derived from natural products or synthesized by methods known to workers in the art. They also are commercially available, typically in the form of a powder, from a number of sources.

The gelling agent may be loaded into the fluid in amounts from about 10 to about 15 ppt (1.2 to about 1.8 kg/m³). Preferably, it may be loaded in amounts from about 10 to about 12 ppt (1.2 to 1.44 kg/m³) as a gelling agent. The precise loading of gelling agent for a particular application will be determined by the degree of viscosity to be imparted to the fluid and may be determined by routine effort. For example, the viscosity of the fluid generally is increased by increasing the polymer concentration. It may be more cost effective, however, to use a higher molecular weight polymer or a polymer having a higher degree of hydrolysis at a relatively fixed polymer concentration. Conversely, the viscosity may be reduced by using a lower molecular weight polymer, a lower polymer concentration, or, in some cases, a polymer having a lower degree of hydrolysis.

It will be appreciated that when specifying ranges, such as the loading of gelling or other components in the fluid, such ranges are intended to describe each value in the range and ranges between any two values. For example, if a guar loading is specified as from about 10 to about 12 ppt, the range describes loadings of about 10 ppt, about 11 ppt, and about 12 ppt, as well as ranges from about 10 to about 11 ppt and from about 11 ppt to about 12 ppt. Similarly, if the range is specified as less than or more than a particular loading, it describes inclusive specific and ranges of loadings.

It will be appreciated, however, that the gelling agent may contribute to or enhance other properties of the fracturing fluid. For example, in certain formations such as shale, the gelling agent also may help minimize fluid losses into a formation by forming a film or filter cake on fractured surfaces. The gelling agent also may tend to encapsulate clay particles and to minimize undesirable increases in viscosity caused by clay in a formation. Guar and other preferred gelling agents also may help reduce friction losses as the fluid is pumped through a liner by reducing turbulent flow in the fluid. As discussed further below, however, in the context of the subject invention it shall be understood that friction reducers shall not be understood as encompassing guar or other gelling agents described herein.

### Crosslinking Agent

The crosslinking agents of the novel fracturing fluids, together with the gelling agent, primarily serves to enhance the viscosity of the fracturing fluid such that it is capable of suspending proppant and delivering it into fractures. They do so by releasing borate ions which create links between the polymers of the gelling agent. The crosslinking agents also are believed to enhance the thioxotropic properties of the fluids, allowing the fluids to recover quickly from relatively low viscosity which allows the fluid to be pumped more easily through a well to a relatively high viscosity which allows the fluid to carry proppant into the fractures. It also will be appreciated that because the crosslinks are reversible, the crosslinking agents also enhance the ability to clean out the gelling agent from fractures.

In various embodiments, the novel fluids utilize borate crosslinking agents which comprise ulexite (NaCaB₅O₆(OH)₆.5H₂O) (hydrated sodium calcium borate hydroxide). Preferably, the crosslinking agent consists essentially of ulexite. Other borates may be present in the fluid, but in general they are not required and may not enhance the improved performance characteristics of the novel fluids.

Ulexite, also known as TV rock, is a borate mineral which is found in evaporative deposits and bedded sedimentary deposits formed from such deposits. It may be is synthesized from borax and CaCl₂. Gulensoy, H., et al., Bull. Miner. Res. Explor. Inst. Turk., vol. 86, pp. 75-78 (1976). Commercially, however, it is primarily sourced by mining such deposits. Since it is commonly found in association with other borates (colemanite, borax, meyerhofferite, hydroboracite, and probertite), sulfates (glauberite, mirabilite, and gypsum), carbonates (trona and calcite), and halides (halite), commercially available ulexite likely contains certain amounts of such minerals.

Ulexite is commercially available from various entities, such as National Boraxx, Cleveland, Ohio, Etimine USA, Pittsburg, Pa., and Economy Polymers & Chemicals, Houston, Tex. It is typically sold as a powder or a liquid slurry in mineral oil. Especially when derived from natural sources, it will be expected that the ulexite will contain certain amounts of its associated borates and minerals. It will be understood, therefore, that in the context of the present disclosure, ulexite will be understood as referring not only to pure ulexite, but also to ulexite mixed with such other associated minerals as may be present in commercially available ulexite, especially ulexite produced from natural sources.

The crosslinking agent generally will be added in amounts sufficient to provide to provide the viscosities desired for a particular application and may be determined by routine effort. In general, viscosity is dependent on the degree or density of crosslinks between polymer. For most applications, that will range from about 0.1 to about 1 mole %. Viscosities will be lower at lower degrees of crosslinking, but less crosslinking may be desirable at higher loadings of gelling agent. Conversely, viscosity generally increases as the degree of crosslinking increases and, correspondingly, the effective molecular weight of the polymer increases. On the other hand, excessive amounts of crosslinking generally will be avoided. As the number of crosslinks among the polymers increases, the polymers may be shaped into relatively compact molecules and their effect on viscosity diminished.

In absolute terms, the amount of crosslinking agent required to achieve a particular crosslink density and fluid viscosity may vary significantly. Ulexite and other polyborates, for example, provide multiple borate ions for each mole of compound. In general smaller amounts will be required as compared to typical monoborates, such as boric acid, although monoborates typically are more soluble. The degree of crosslinking also varies depending on the pH. At higher pH, the borate is more soluble and more borate ion is released, and that tends to increase the degree of crosslinking and temperature of the gelled fluid. Higher temperatures, on the other hand, tend to decrease the degree of crosslinking.

Bearing the foregoing in mind, however, in general ulexite will be loaded into the novel fluids from about 0.1 to about 0.25 grams per 100 milliliters (g/100 ml). Preferably, the loading will be from about 0.1 to about 0.2 g/100 ml. Workers in the art will be able to determine the precise amount of ulexite in the novel fluids which is suitable for a particular application.

### Proppants

The novel fluids preferably comprise a proppant. As described further below, proppants typically will be added to the fluid after an initial, proppant-free pad of fluid has been injected into the well. The proppants primarily serve to support fractures created in a formation and to minimize closing of the fractures after completion of the fracturing operation. They do so by physically resisting the stress present in the fractured formation.

In general, the novel fluids may incorporate any of the proppants conventionally used in fracturing fluids. Such proppants are natural and synthetic particulates, such as natural sand, quartz sand, particulate garnet, glass, gravel, ground walnut hulls, nylon pellets, aluminum pellets, bauxite, ceramics, polymeric materials, and combinations thereof. The particulates also may be coated with resins, tackifiers, surface modification agents, or combinations thereof. If used, those coatings should not undesirably interact with the proppant particulates or any other components of the treatment fluids of the s present inventions. Workers in the art, with the benefit of this disclosure, will recognize the appropriate type, size, and amount of proppant particulates to use in conjunction with the well treatment fluids of the present disclosure, so as to achieve a desired result.

A variety of suitable proppants and their properties are well known to workers in the art and are commercially available from many sources.

### Breakers

The novel fluids preferably comprise a breaker. As described further below, breakers typically will be added to the fluid late in the fracturing process. They will reduce the viscosity of the fluids and assist in clean out of the fluid. More specifically, the breaker primarily serves to reduce the size and molecular weight of the polymers in the gelling agent so the gelling agent cleans out of the fractures more efficiently. They may do so by reversing the crosslinks created by the crosslinking agent. Alternately, or additionally, they may break polymer bonds, essentially shortening the polymer chains.

Various conventional breaking agents may be used in the novel fluids. Such breakers include enzymes, oxidizers, polyols, and aminocarboxylic acids. Preferably, the breaker is an oxidizer such a hydrogen peroxide. The breaker may be encapsulated in polymer to delay their release into the fluid. The breaker typically will be loaded into the fluid in amounts from about 0.1 to about 1 ppt. The specific loading of breaker for a particular application, however, will be determined by the desired degree of viscosity to be imparted to the fluid.

A variety of suitable breakers and their properties are well known to workers in the art and are commercially available from many sources. Workers in the art, with the benefit of this disclosure, will recognize the appropriate breaker and amount of breaker to use in conjunction with the novel fluids so as to achieve a desired result.

### Additives

The subject invention is believed to provide significant advantages in controlling the viscosity of aqueous fracturing fluids primarily through the use of the gelling agents, crosslinking agents, and breakers described herein. The novel fluids, however, may be used to fracture many different formations presenting a wide variety of conditions. Thus, certain embodiments of the novel fluids may comprise additives designed to enhance the performance of the fluids in other way as may be required or desirable under specific conditions. Many such additives are known to workers in the art, are commercially available from a number of sources, and in general may be used in the novel fluids provided they are compatible with the other components.

Such additives include suspending agents/anti-settling agents, stabilizers, chelators/sequestriants, non-emulsifiers, fluid loss additives, biocides, buffering agents, weighting agents, wetting agents, lubricants, friction reducers, anti-oxidants, pH control agents, oxygen scavengers, surfactants, fines stabilizers, metal chelators, metal complexors, antioxidants, polymer stabilizers, clay stabilizers, freezing point depressants, scale inhibitors, scale dissolvers, shale stabilizing agents, corrosion inhibitors, wax inhibitors, asphaltene precipitation inhibitors, leak-off control agents, permeability modifiers, gases, and foaming agents and combinations thereof, such that none of the optionally-included additives adversely react or effect the other constituents of these inventions. It is generally expected that additives of the type used in aqueous, borate crosslinked fracturing fluids may be used to advantage in the novel fluids, and the desirability and compatibility of such conventional additives may be determined by routine experimentation.

It will be noted, however, that preferred embodiments of the novel fluids do not comprise an additional friction reducer. Friction reducers are added to water to lower friction pressure during pumping. Typically, they are long chain, high molecular weight polymers that are water soluble. Water in turbulent flow has high friction pressure. Friction reducers generally lower friction pressure by increasing laminar flow and decreasing turbulent flow in the water as it is pumped down the wellbore. Common friction reducers used in borate crosslinked fracturing fluids include polyacrylamide polymers and copolymers. While they may be regarded as such by some, non-crosslinked guar and the other gelling agents described herein are not considered to be friction reducers for purposes of this disclosure.

It also will be noted that preferred embodiments of the novel fluids tend to be self-buffering. Thus, it generally will not be necessary to provide additional pH control agents or buffers. At the same time, however, for specific applications it may be desirable to adjust the pH of the fluids. For example, more borate ions generally will be released as the pH is increased, which tends to produce a corresponding increase in crosslinking.

### Making and Using the Novel Fluids

Typical components and their concentrations in the novel fluids are described above. The choice of particular components among those generally suitable for use in the novel fluids and the concentration thereof, however, will depend on the precise chemical and physical properties of the fluid that are needed for a particular fracturing operation. Cost considerations also may come into play. Workers in the art may optimize the precise formulation of the novel fluids for a particular application by reference to principles well known in the art and by routine experimentation.

Moreover, it will be appreciated that various functions and mechanisms have been ascribed to each component of the novel fluids and their effect of the overall properties of the fluid. While such explanations are believed to be accurate, and are believed to provide useful guidance in making and using the novel fluids, it will be understood that the invention is not limited thereby. As demonstrated by the examples which follow, regardless of their respective individual properties, the mechanism by which they function, or their effectiveness in other fluids, the combination of the gelling agent and crosslinker as described synergistically provide the novel fracturing fluids with improved viscosity characteristics at lower loadings of gelling agent.

In particular, the novel fluids have relatively low viscosities under high shear conditions, and thus are expected to exhibit relatively low pressure losses as they are pumped through a well. They also have sufficiently high viscosities under low shear conditions, and thus are expected to efficiently transport proppant into fractures. Importantly, the novel fluids recover viscosity more rapidly when transitioning from high shear conditions to low shear conditions. It is expected, therefore, that the novel fluids will transfer proppant more uniformly into fractures.

More particularly, it is expected that the novel fluids may provide fluids with viscosities of less than about 20 cP, or less than about 15 cP at high shear rates, but have viscosities of at least about 25 cP, or at least about 50 cP at low shear rates. The novel fluids also may provide rapid recovery from high shear viscosity to low shear viscosity. For example, the fluids may recover from high shear viscosities of less than about 20 cP, or less than about 15 cP, to low shear viscosities of at least about 25 cP in less than about 10 seconds. Such fluids also may recover to low shear viscosities of at least about 50 cP in less than about 3 minutes. The novel fluids also may recover from high shear viscosities of less than about 20 cP, or less than about 15 cP, to low shear viscosities of at least about 100% greater than the high shear viscosity in less than about 10 seconds. In other embodiments, they may recover from high shear viscosities of less than about 15 cP to low shear viscosities of at least about 150% greater than the high shear rate viscosity in less than about 90 seconds, or at least about 200% greater than the high shear rate viscosity in less than about 2 minutes, or at least about 300% greater than the high shear rate viscosity in less than about 3 minutes. It will be appreciated that such recovery from high shear to low shear viscosity are believed to be significantly better than conventional borate crosslinked fluids.

It will be appreciated that terms such as high and low shear rates and high and low shear viscosities at times are mentioned in this disclosure in a general sense. When quantifying the characteristics or performance of the novel fluids, however, and consistent with the Examples set forth below, “high shear rate” is defined as 511 revolutions per second (rps) and “low shear rate” is defined as 100 rps. Similarly, “high shear rate viscosity” is defined as the median viscosity of a fluid recorded every 5 seconds in the last minute of a 3-minute period of high shear rates according to the procedures specified in the Examples. “Low shear rate viscosity” is defined as the median viscosity of a fluid recorded every 5 seconds in the first minute after transitioning from high shear rates to low shear rates except when referencing the speed or rate of recovery. In such instances, “low shear rate viscosity” is simply the viscosity recorded at the applicable time.

It also will be appreciated that such viscosity control and performance is achieved with relatively low loading of gelling agent. For example, in conventional borate crosslinked fluids, guar is typically loaded in amounts greater than about 20 ppt. The novel fluids, however, comprise guar at loadings from about 10 to about 15 ppt, and preferably, from about 10 to about 12 ppt. Given the large quantities of fluid typically required for a fracturing operation, reducing the relative amounts means that in absolute terms much less gelling agent will be required. Other common additives, such as friction reducers and buffers, also may not be required in many embodiments of the subject invention. Thus, it is expected the novel fluids will provide comparable or improved performance at significantly less cost.

In general, the novel fracturing fluids may be made and circulated by methods and equipment well known and used by workers in the art. For example, an aqueous base fluid typically will be stored on site in tanks. Similarly, sand tanks may be used to store to proppant on site. The gelling agent, crosslinking agent, breaker, and other additives is typically will be transported on site by a chemical unit. A hydration unit may be used to blend the gelling agent, crosslinking agents, and other components into the aqueous base fluid to produce a gelled base fluid. A mixer may be used to mix proppant into the gelled is base fluid. An array of hydraulic pumps may be used to pressurize the fluid and to discharge it into a frac manifold which is connected to the well head by various conduits commonly referred to as frac iron. Recovery tanks typically will be used to recover the fracturing fluid for treatment, reconstitution, or disposal.

While the sequence of operations can vary, a gelled base fluid may first be prepared by adding gelling agent to an aqueous base fluid. Depending on the gelling agent, a period of time may be required to allow the gelling agent to sufficiently hydrolyze. An initial pad of gelled base fluid may be pumped into the well to initiated fracturing. The crosslinking agent then may be added to prepare the gelled base fluid for the addition of proppant. After pumping a quantity of proppant into the well, the breaker preferably will be added to facilitate clean out of the fluid from the fractures. In the earlier stages of pumping, encapsulated breakers with delayed activation usually will be added. Un-encapsulated or “live” breakers usually follow later in the operation.

The fluids may be prepared in batches, or they may be prepared or supplemented on the fly. Pumping rates and quantities of fluid pumped also can vary considerably depending on the particular fluid and formation to be fractured. As an example, however, it is expected that shale formations typically may be fractured by pumping from about 8,000 to about 14,000 barrels of the novel fluid at rates from about 60 to about 100 bbl/min.

Also, while the novel fluids have been described for use in fracturing formations, g it will be appreciated that they also may be used to advantage in various completion or workover operations as are typically performed to enhance production from a hydrocarbon well. For example, the novel fluids may be used to form a gravel pack in a well.

### EXAMPLES

The invention and its advantages may be further understood by reference to the following examples. It will be appreciated, however, that the invention is not limited thereto.

### Examples

### Materials, Equipment, and General Procedures

Test fluids for the examples that followed were prepared using the following components:

Base fluid—tap water from Calgary, Canada.

Gelling agent—powdered guar.

Crosslinker—an approximately 20 wt % aqueous solution of boric acid available commercially under the product name S-314 from Rockwater Energy Solutions, Houston, Tex.

Crosslinker—ulexite available in a 39 wt % mineral oil suspension under the product name Ecopol DBXL-90 from Economy Polymers & Chemicals, Houston, Tex.

Buffer 1—45 wt % aqueous solution of potassium carbonate.

Buffer 2—35 wt % aqueous solution of potassium carbonate.

Buffer 3—aqueous solution of 25 wt % potassium hydroxide and 15 wt % methanol.

Clay Inhibitor—a 70 wt % solution of choline chloride.

Surfactant—a nonionic surfactant consisting of an aqueous solution of 3 wt % ethanol and 3 wt % secondary alcohol ethoxylate available commercially Flotek Industries, Inc. Houston, Tex.

Test fluids were tested using a Model 5550 HPHT (high pressure high temperature) viscometer sold by Chandler Engineering (Ametek, Inc.), Broken Arrow, Oklahoma. The viscometer is a concentric cylinder viscometer using a stationary cup and a rotating bob. The cup had a radius of 1.8415 cm. The bob was a BX5 bob having a radius of 1.5987 cm and a height of 7.62 cm. Test procedures and data acquisition are controlled by a computer running Chandler Rheo 5000 software. The viscometer was calibrated prior to testing using silicone oil having a viscosity of 200 centistokes (cst) obtained from Chandler Engineering according to the manufacture's standard calibration procedures.

Approximately 50 ml of fluid was added to the cup, filling the cup to a level approximately 2-3 inches above the top of the bob. Fluids were added at a temperature of 75° F. The temperature was ramped up to 150° F. over the course of six minutes and maintained at that temperature for the duration of testing. The fluids first were subjected to high shear rates (511 rps) for a period of 3 minutes and to low shear rates (100 rps) for at least an additional 15 minutes. Viscosity (cP) and temperature (° F.) were recorded every 5-6 seconds, and plots were prepared of viscosity and temperature as a function of time. The plots also record the time (3 minutes) at which the shear rate was dropped from high to low (Δ shear).

It will be noted that the high shear rates may be generally correlated to conditions experienced by fluids being pumped down a liner. The low shear rates may be generally correlated to conditions that are experienced by fluids in the vicinity of the openings in a liner, i.e., as they exit the liner arid begin to enter a formation.

### Example 1

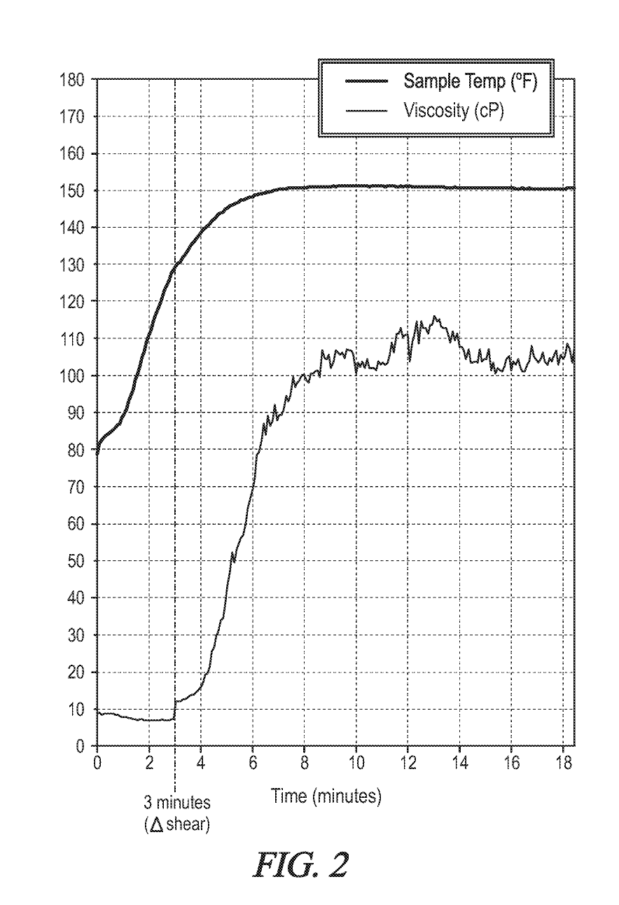

A first conventional test fluid having a guar loading of about 15 ppt and a loading of about 1 gpt (gallons per thousand gallons) boric acid crosslinker solution was prepared. The fluid was prepared by adding 7.5 grams (gm) of guar to 500 milliliters (ml) of water in a rod blender running about 800 rpm for 30 minutes to allow the guar to hydrate and form a gelled base fluid. Next, the gelled base fluid was placed in a blender rotating at 2,000 rounds per minute (rpm) and 1 ml of buffer 1 was added followed by 0.5 ml of boric acid. The fluid was mixed for an additional 30 seconds, and 50 ml of the fluid was transferred to the viscometer. The pH of the fluid was not measured, but is expected to have been in the range of about 10 to 11.3. The test fluid was tested as described above, and yielded the data presented graphically in FIG. 2.

It will be noted that FIG. 2 plots viscosity and temperature as a function of time. The drop in shear rate (ΔS) from high shear (511 rps) to low shear (100 rps) is indicated on FIG. 2 at t=3 minutes.

### Example 2

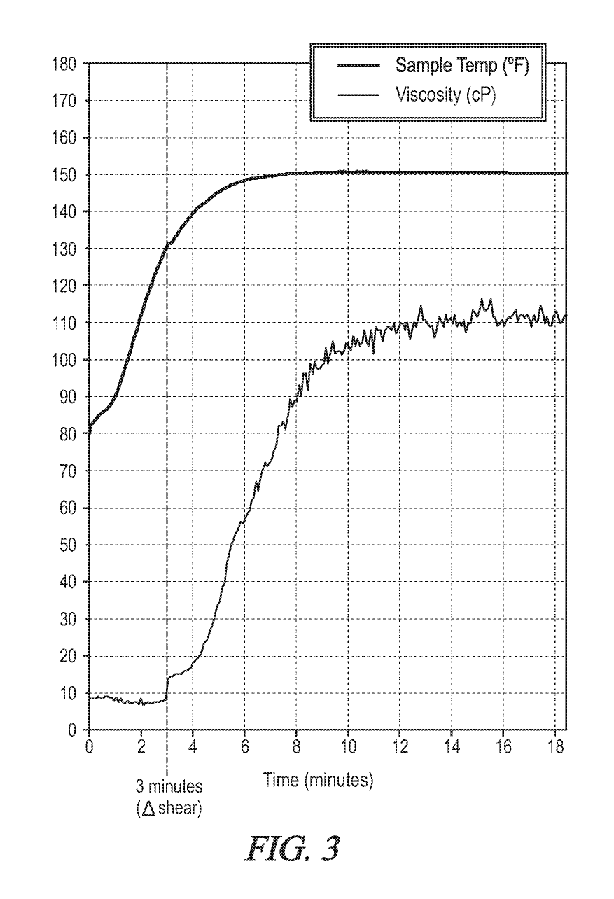

A second conventional test fluid was prepared and tested as describe above in Example 1 except that 0.75 ml of buffer 1 was used. The pH of the fluid was not measured, but is expected to have been in the range of about 10 to 11.3. The testing yielded the data presented graphically in FIG. 3.

### Example 3

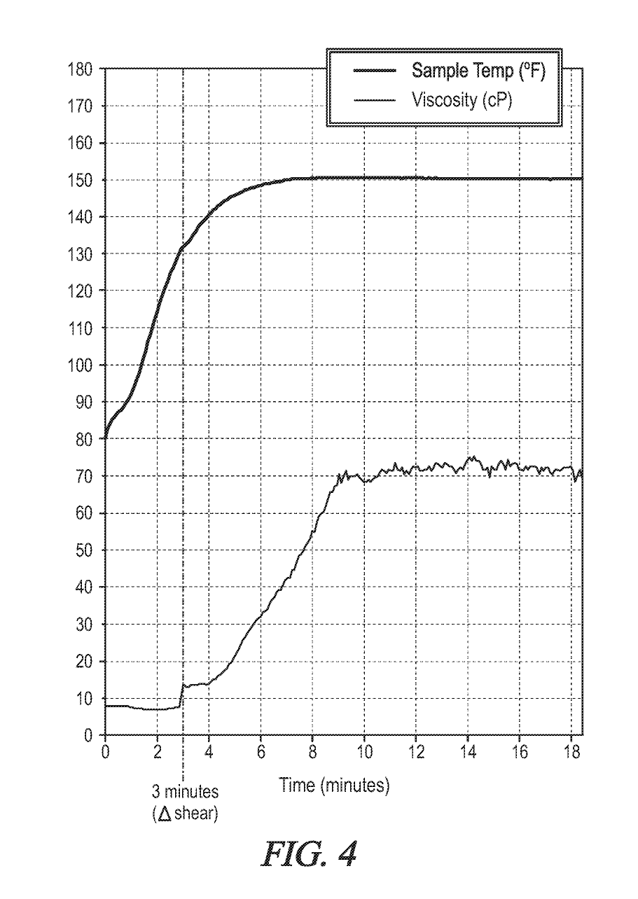

A third conventional test fluid was prepared and tested as describe above in Example 1 except that 0.5 ml of buffer 1 was used. The pH of the fluid was not measured, but is expected to have been in the range of about 10 to 11.3. The testing yielded the data presented graphically in FIG. 4.

### Example 4

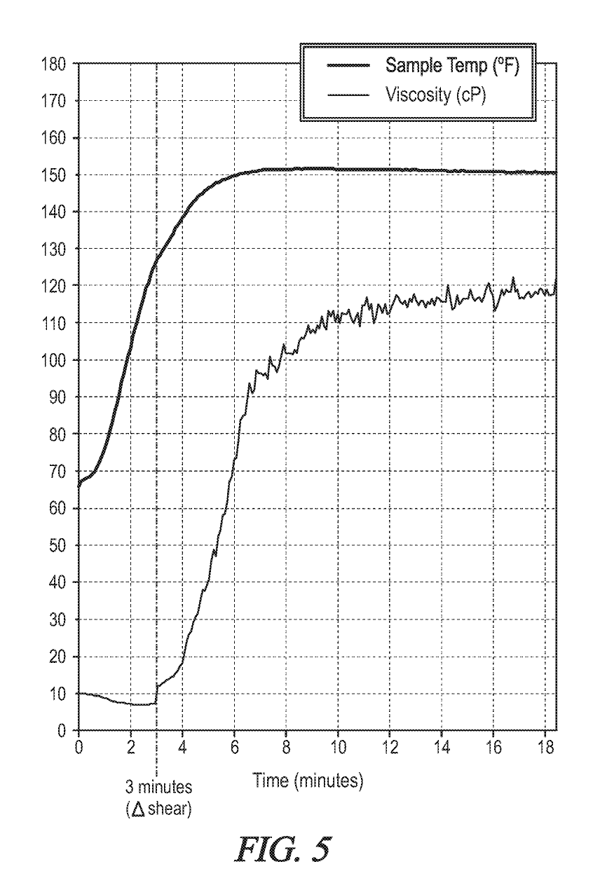

A fourth conventional test fluid was prepared and tested as describe above in Example 1 except that 0.5 ml of buffer 2 was used. The pH of the fluid was not measured, but is expected to have been in the range of about 10 to 11.3. The testing yielded the data presented graphically in FIG. 5.

### Example 5

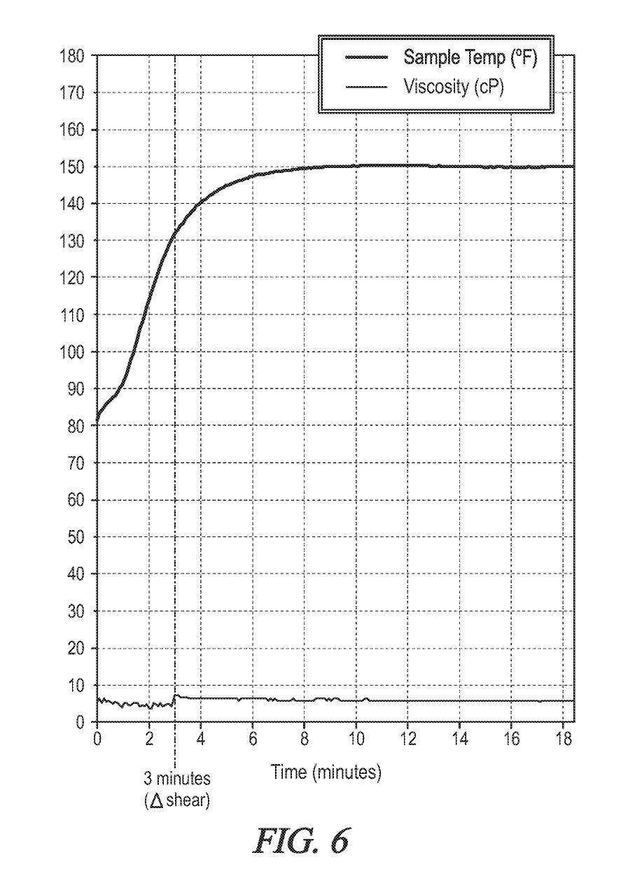

A fifth conventional test fluid was prepared having a guar loading of about 10 ppt and a loading of about 1 gpt boric acid crosslinker solution. The fluid was prepared and tested as describe above in Example 1 using 500 ml of water, 5 gm of guar, 0.5 ml of boric acid, and 0.5 ml of buffer 2. The pH of the fluid was not measured, but is expected to have been in the range of about 10 to 11.3. The testing yielded the data presented graphically in FIG. 6.

### Example 6

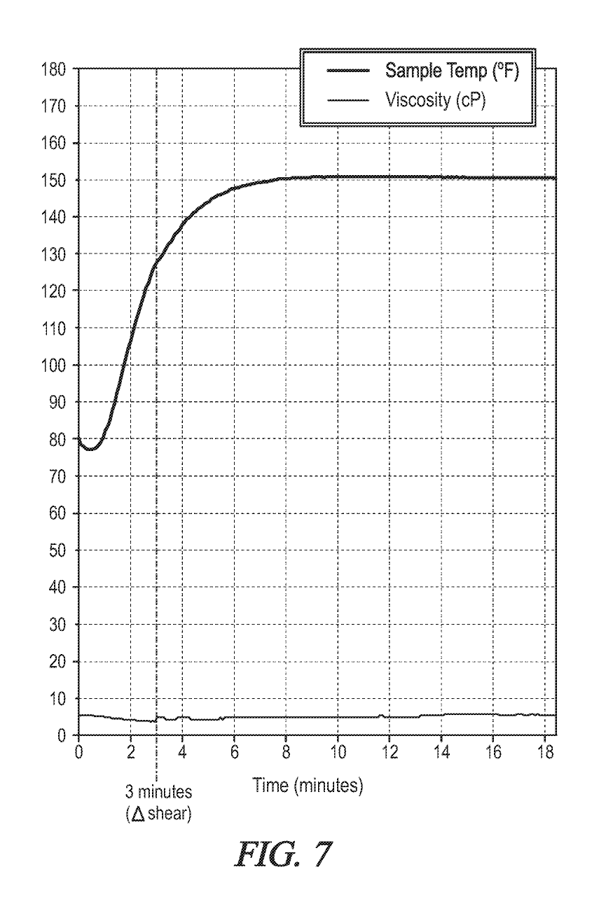

A sixth conventional test fluid was prepared and tested as describe above in Example 5 except that 1 ml of buffer 2 was used. The pH of the fluid was not measured, but is expected to have been in the range of about 10 to 11.3. The testing yielded the data presented graphically in FIG. 7.

### Example 7

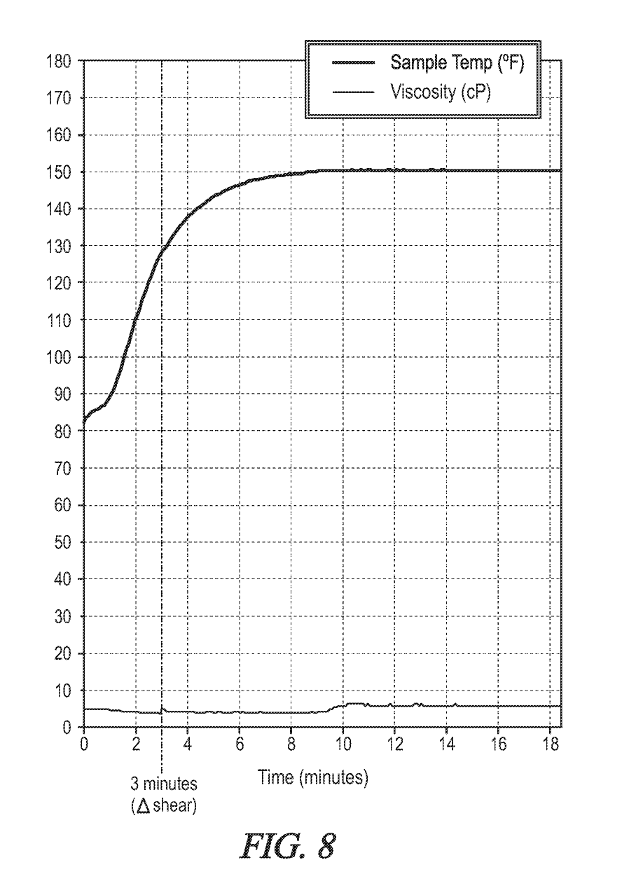

An eighth conventional test fluid was prepared and tested as describe above in Example 5 except that 1 ml of buffer 3 was used. The pH of the fluid was not measured, but is expected to have been in the range of about 10 to 11.3. The testing yielded the data to presented graphically in FIG. 8.

### Example 8

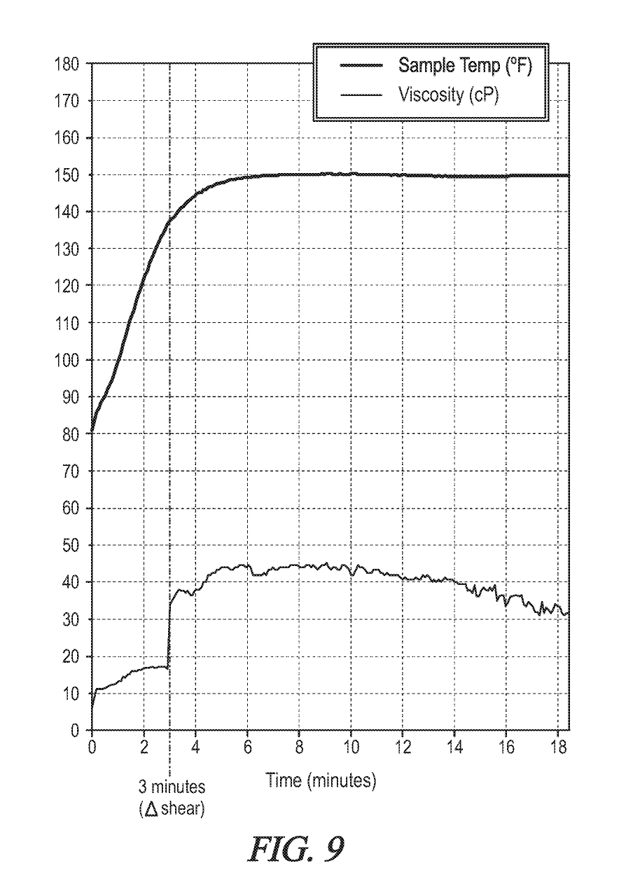

A first novel test fluid was prepared having a guar loading of about 10 ppt and a loading of about 3 gpt ulexite crosslinker suspension. The fluid was prepared by adding 5 gm of guar to 500 mls of water in a rod blender running at about 800 rpm for 30 minutes to allow the guar to hydrate and form a gelled base fluid. Next, the gelled base fluid was placed in a blender rotating at 2,000 rounds per minute (rpm) and 1.5 ml of ulexite suspension (about 0.67 g ulexite) was added to the gelled base fluid. The fluid was mixed for an additional 30 seconds, and 50 ml of the fluid was transferred to the viscometer. The pH of the fluid was not measured, but is expected to have been in the range of about 9.5 to 9.6. The test fluid was tested as described above, and yielded the data presented graphically in FIG. 9.

### Example 9

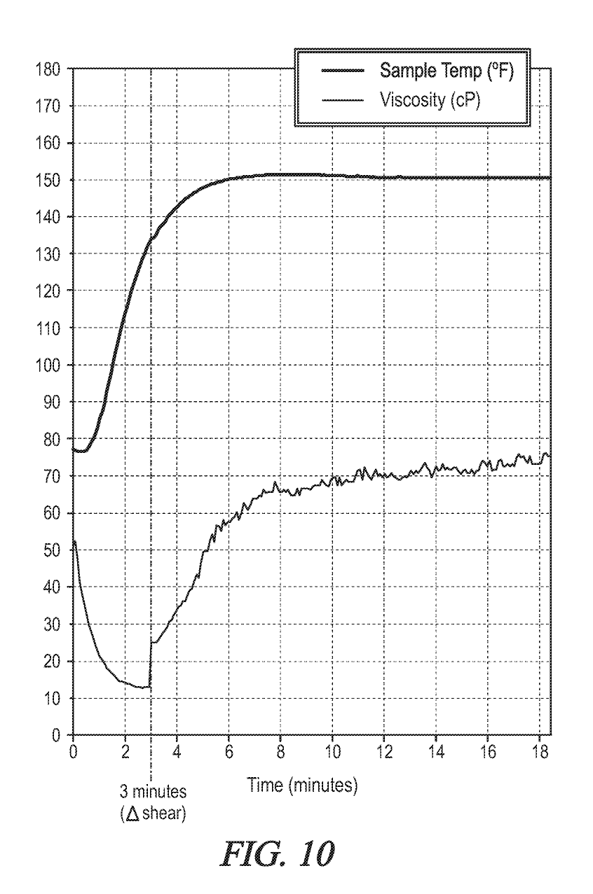

A second novel test fluid was prepared and tested as describe above in Example 9 except that 2 ml of ulexite suspension (about 0.90 g ulexite) was used, providing the fluid with a ulexite suspension loading of about 4 gpt. The pH of the fluid was not measured, but is expected to have been in the range of about 9.5 to 9.6. The testing yielded the data presented graphically in FIG. 10.

### Example 10

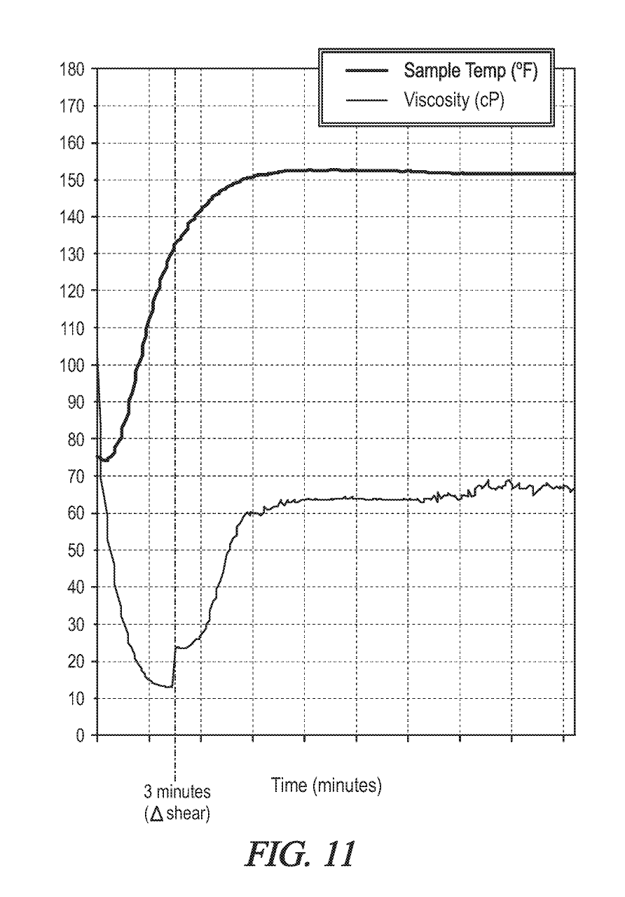

A third novel test fluid was prepared and tested as describe above in Example 9 except that 2 ml of ulexite suspension (about 0.90 g ulexite) was used, providing the fluid with a ulexite suspension loading of about 4 gpt. In addition, 0.5 ml of clay inhibitor and 0.25 ml of surfactant were added to the gelled fluid after the addition of the ulexite. The pH of the fluid was riot measured, but is expected to have been in the range of about 9.5 to 9.6. The testing yielded the data presented graphically in FIG. 11.

A summary of the test fluids, including the loading of the various components and test results, is set forth below in Table 1.

TABLE 1

| Test | Gelling | | | Clay | | |
|---|---|---|---|---|---|---|
| Fluid | Agent | Crosslinker | Buffer | Inhibitor | Surfactant | Results |
| 1 | 15 ppt guar | 1 gpt boric acid | 1 ml No. 1 | — | — | FIG. 2 |
| 2 | 15 ppt guar | 1 gpt boric acid | 0.75 ml No. 1 | — | — | FIG. 3 |
| 3 | 15 ppt guar | 1 gpt boric acid | 0.5 ml No. 1 | — | — | FIG. 4 |
| 4 | 15 ppt guar | 1 gpt boric acid | 0.5 ml No. 2 | — | — | FIG. 5 |
| 5 | 10 ppt guar | 1 gpt boric acid | 0.5 No. 2 | — | — | FIG. 6 |
| 6 | 10 ppt guar | 1 gpt boric acid | 1 ml No. 2 | — | — | FIG. 7 |
| 7 | 10 ppt guar | 1 gpt boric acid | 1 ml No. 3 | — | — | FIG. 8 |
| 8 | 10 ppt guar | 3 gpt ulexite | — | — | — | FIG. 9 |
| 9 | 10 ppt guar | 4 gpt ulexite | — | — | — | FIG. 10 |
| 10 | 10 ppt guar | 4 gpt ulexite | — | 0.5 ml | 0.25 ml | FIG. 11 |

It will be noted from the data presented in FIGS. 2-5, that conventional Fluids 1 to 4, all of which have guar loadings at 15 ppt, have relatively low viscosities at high shear rates. Such data indicate that the fluids will experience relatively small pressure losses as they are pumped down a liner toward a formation. They also have relatively high viscosities at low shear rates, suggesting that they will efficiently carry proppant into a formation. It will be noted, however, that the fluids do not transition rapidly to a higher viscosity state. In general, the fluids did not recover to a viscosity of at least 25 cP until about 1.5 to 2.5 minutes after transitioning to a low shear environment. Such data indicate that conventional Fluids 1 to 4 will not have sufficient viscosity to efficiently transport proppant after exiting a liner and entering a formation.

The data presented in FIGS. 6-8 for Test Fluids 5 to 7 show that those fluids also have low viscosities at high shear rates and likely will experience relatively small pressure losses during pumping. Having relatively low loadings (10 ppt) of guar, however, they never achieve sufficient viscosity at low shear rates. Thus, conventional Fluids 5 to 7 would not be expected to carry proppant efficiently into fractures.

In contrast, novel Fluids 8 and 9, as shown in FIGS. 9-10, have low high-shear viscosity but high low-shear viscosity. Thus, like conventional Fluids 1 to 7, they should experience relatively small pressure losses as they are pumped into a well. In contrast to conventional Fluids 5-7, however, the low shear test results suggest that they will efficiently carry proppant into a formation despite the low level of guar loaded into the fluid (10 ppt). More importantly, it will be noted that novel Fluids 8 and 9 transition very quickly from a low viscosity to a high viscosity once the shear rate is lowered. In particular, it will be noted that conventional Fluids 1-4 did not recover to a viscosity of at least 25 cP for at least approximately 1.5 to 2.5 minutes. Novel Fluids 8 and 9, however, recovered to a viscosity of at least 25 cP in a matter of a few seconds. Such data indicate that the novel fluids will rapidly gain sufficient viscosity after exiting a liner and upon entering a formation to efficiently transport proppant.

Novel fluid 10, the data for which is presented in FIG. 11, is similar to novel Fluids 8 and 9 except that it incorporates a clay inhibitor and a surfactant to aid in dispersing entrained clay particles. The data indicate that novel Fluid 10 also has low high-shear viscosity, high low-shear viscosity, and fast recovery despite the presence of such additives.

Table 2 below sets forth some representative data showing the recovery time for conventional Fluids 1 to 4 and novel Fluids 8, 9, and 10, where V_{H} is the median viscosity (cP) reading during the last minute of high shear conditions, V_{L} is the median viscosity (cP) reading during the first minute after transitioning to low shear conditions, and T₂₅, T₄₀, and T₅₀ are, respectively, the time (minutes:seconds) required for the fluid to recover to viscosities of 25 cP, 40 cP, and 50 cP.

TABLE 2

| Fluid | V_{H} (cP) | V_{L} (cP) | T₂₅ (min:sec) | T₄₀ (min:sec) | T₅₀ (min:sec) |
|---|---|---|---|---|---|
| 1 | 7.0 | 13.2 | 4:29 | 5:05 | 5:21 |
| 2 | 7.6 | 14.9 | 4:38 | 5:17 | 5:32 |
| 3 | 7.3 | 13.5 | 5:20 | 6:53 | 7:44 |
| 4 | 7.0 | 14.2 | 4:16 | 5:04 | 5:22 |
| 8 | 17.0 | 37.0 | <0:06 | 2:24 | — |
| 9 | 13.0 | 27.8 | 0:06 | 4:42 | 5:18 |
| 10 | 13.3 | 24.3 | 0:47 | 4:47 | 5:09 |

The foregoing examples demonstrate that the viscosity of the novel fluids may be controlled more effectively to provide relatively low viscosities during pumping, i.e., less pressure loss, and a very quick transition to high viscosities, i.e., efficient proppant transport. It is anticipated, therefore, that the novel fluids will allow for more efficient, more cost effective fracturing operations.

While this invention has been disclosed and discussed primarily in terms of specific embodiments thereof, it is not intended to be limited thereto. Other modifications and embodiments will be apparent to the worker in the art.

1. An aqueous well treatment fluid, said well treatment fluid comprising:
(a) a gelling agent selected from the group consisting of galactomannan gum and derivatives thereof in an amount from about 10 to about 15 ppt; and
(b) a borate crosslinking agent comprising ulexite.

2. The fluid of claim 1, wherein said gelling agent is present in an amount from about 10 to about 12 ppt.

3. The fluid of claim 1, wherein said gelling agent is guar.

4. The fluid of claim 1, wherein said crosslinking agent is present in an amount effective to provide said fluid with a viscosity of less than about 20 cP at high shear rates and at least about 25 cP at low shear rates.

5. The fluid of claim 1, wherein said crosslinking agent is present in an amount effective to provide said fluid with a viscosity of less than about 15 cP at high shear rates and at least about 25 cP at low shear rates.

6. The fluid of claim 1, wherein said crosslinking agent is present in an amount effective to provide said fluid with a viscosity of less than about 20 cP at high shear rates and at least about 50 cP at low shear rates.

7. The fluid of claim 1, wherein said crosslinking agent is present in an amount effective to provide said fluid with a viscosity of less than about 15 cP at high shear rates and at least about 50 cP at low shear rates.

8. The fluid of claim 1, wherein said crosslinking agent consists essentially of ulexite.

9. The fluid of claim 7, wherein ulexite is present in amounts sufficient to provide from about 0.1 to about 1 mole % crosslinking.

10. The fluid of claim 7, wherein ulexite is present in an amount from about 0.1 to about 0.2 g/100 ml.

11. The fluid of claim 1, said fluid recovers from a high shear rate viscosity of less than about 20 cP to a low shear rate viscosity of at least about 25 cP in less than about 10 seconds.

12. The fluid of claim 1, said fluid recovers from a high shear rate viscosity of less than about 15 cP to a low shear rate viscosity of at least about 25 cP in less than about 10 seconds.

13. The fluid of claim 1, said fluid recovers from a high shear rate viscosity of less than about 15 cP to a low shear rate viscosity of at least about 50 cP in less than about 3 minutes.

14. The fluid of claim 1, said fluid recovers from a high shear rate viscosity of less than about 20 cP to a low shear rate viscosity of at least about 100% greater than said high shear rate viscosity in less than about 10 seconds.

15. The fluid of claim 1, said fluid recovers from a high shear rate viscosity of less than about 15 cP to a low shear rate viscosity of at least about 100% greater than said high shear rate viscosity in less than about 10 seconds.

16. The fluid of claim 1, said fluid recovers from a high shear rate viscosity of less than about 15 cP to a low shear rate viscosity of at least about 150% greater than said high shear rate viscosity in less than about 90 seconds.

17. The fluid of claim 1, said fluid recovers from a high shear rate viscosity of less than about 15 cP to a low shear rate viscosity of at least about 200% greater than said high shear rate viscosity in less than about 2 minutes.

18. The fluid of claim 1, said fluid recovers from a high shear rate viscosity of less than about 15 cP to a low shear rate viscosity of at least about 300% greater than said high shear rate viscosity in less than about 3 minutes.

19. The fluid of claim 1, wherein said fluid does not comprise additional friction reducers.

20. An aqueous well treatment fluid, said well treatment fluid comprising viscosity enhancing additives, said viscosity enhancing additives consisting essentially of:
(a) a gelling agent selected from the group consisting of galactomannan gum and derivatives thereof in an amount from about 10 to about 15 ppt; and
(b) a borate crosslinking agent comprising ulexite.

21. The well treatment fluid of claim 20, wherein said gelling agent is present in an amount from about 10 to about 12 ppt.

22. The well treatment fluid of claim 20, wherein said crosslinking agent consists essentially of ulexite.

23. The well treatment fluid of claim 20, wherein said fluid comprises a breaker.

24. A method of fracturing a formation extending around a well, said method comprising:
(a) pumping the fluid of claim 1 into the formation at a rate and pressure sufficient to form fractures in the formation.

25. A method of controlling the viscosity of an aqueous fluid injected into a well to induce fracturing of adjacent formations, said method consisting of:
(a) adding a gelling agent selected from the group consisting of galactomannan gum and derivatives thereof in an amount from about 10 to about 15 ppt and a borate crosslinking agent comprising ulexite to increase the viscosity of said aqueous fluid; and
(b) adding a breaker to decrease the viscosity of said aqueous fluid.

26. The fluid of claim 1, wherein said fluid comprises a proppant.

27. The well treatment fluid of claim 20, wherein said fluid comprises a proppant.
